(19) United States
(12) Patent Application Publication
(10) Pub. No.: US 2004/0239952 A1
(43) Pub. Date: Dec. 2, 2004

(54) Sensor for visual position detection with a modular lighting unit

(75) Inventor: Werner Mueller, Holzkirchen (DE)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 10/866,796

(22) Filed: Jun. 15, 2004

Related U.S. Application Data
(63) Continuation of application No. PCT/DE02/04574, filed on Dec. 13, 2002.

(30) Foreign Application Priority Data
Dec. 18, 2001 (DE) 101 62 270.8

(51) Int. Cl. G01B 11/14

(52) U.S. Cl. 356/614

(57) ABSTRACT

The present invention relates to a modular optical sensor device having an optical base module and a supplemental or supplementary module. The supplemental module may be disposed on the optical base module and replaced by other supplemental optical modules. The supplementary optical modules have different lighting characteristics. Depending on the kind of the object to be detected, a supplemental module can be chosen which is suitable with respect to the lighting angle and the spectral distribution of the illuminating light. According to one embodiment, the optical base module is coupled to the supplemental optical module via an interface so that the supplemental optical module can be identified by a central control unit and the optical sensor device does not have to be calibrated when the supplemental module is exchanged.

### CROSS REFERENCE TO RELATED APPLICATIONS

The present application is a continuation of international application PCT/DE02/04574, filed 12.13.2002, which designated the United States, and further claims priority to priority patent application DE10162270.8, filed 12.18.2001, the both of which are herein incorporated by reference.

### BACKGROUND OF THE INVENTION

The present invention relates to an optical sensor device as well as to individual components thereof. The optical sensor device is used for the visual detection of objects, in particular for position detection and/or for the recognition or checking of components and/or substrates.

The automatic equipping of substrates or printed circuit boards with components is currently performed by means of automatic pick-and-place machines. Herein, components are transported from a component feed device, by means of an assembly head, to a mounting position on a printed circuit board. The term ‘components’ as used herein is understood to include all mountable elements, particularly electronic components, electromechanical components, connectors and plug-in connectors for electrical and mechanical contacts, and screening plates. Mountable elements may also include dies or individual parts of a semiconductor wafer which, in particular after the wafer has been structured and cut, are further processed to produce finished components.

As a result of recent and increasing component miniaturization, a correct mounting operation is dependent on a precise positional measurement both of the component to be mounted and also of the printed circuit board on which the component is to be mounted. Moreover, in order to satisfy the requirement for a high mounting capacity, the mounting operation must be performed not only precisely but must also be carried out very quickly. This requirement can only be met by using an optical means of detecting the components and/or the substrates.

An optical detection facility of this type enables the detection of mechanically defective or damaged components with the result that the probability of faults affecting a mounting operation can be significantly reduced. An optical detection facility can furthermore be used to precisely establish the position of a component to be mounted and/or of a printed circuit board, thereby enabling an important prerequisite to be satisfied with regard to a high degree of precision for the mounting operation.

Markings which are applied to the printed circuit boards and which can be detected by optical sensor devices are used in order to detect a precise position of the printed circuit boards. Light markings on a relatively dark background or dark markings on a relatively light background are employed for marking purposes, depending on the material used for the printed circuit board.

Correct detection of component and/or substrate does however also require a means of lighting which is matched in each case to the objects to be detected, the matching being by way of lighting angle, in other words the angle at which the illumination light strikes the object in question, and in respect of the spectral distribution of the illumination light. For this reason, sensor devices have been developed with lighting systems which create the most suitable lighting possible for visual detection of the objects for a large number of different substrates and/or components.

A lighting system is thus known, for example, from U.S. Pat. No. 5,469,294 which comprises one or more light sources, opaque separating walls and mirrors. The light sources include both light emitting diodes (LEDs) and also incandescent lamps emitting over a wide spectral range. Dark-field lighting systems (the illumination is essentially parallel to the optical axis of a camera) and bright-field lighting systems (the illumination is essentially perpendicular to the optical axis of the camera) are provided in order to achieve improved recognition both of light objects on a dark background and also of dark objects on a light background.

A lighting device is known from WO 99/20093 which comprises a plurality of lighting units that each emit light in a different spectral range from one another. The lighting units can be varied separately in respect of their intensity. As a result, an illumination having a variable spectral distribution is achieved which serves to guarantee a sufficient degree of contrast when using different objects or markings against light backgrounds of different degrees of lightness.

The aforementioned lighting systems have the disadvantage that as a result of their complexity they are expensive to manufacture and are difficult to use, in other words in respect of setting the illumination required in each case. A further disadvantage associated with the aforementioned lighting devices includes the fact that they are not suitable for all components or printed circuit boards. Thus, when using other printed circuit boards and/or components for which the lighting devices are not suitable the automatic pick-and-place machine must be modified appropriately in order to achieve an illumination set-up appropriate to the specific application instance. A modification of this type generally requires a re-calibration of the lighting equipment and moreover always has associated additional costs and downtime in respect of the automatic pick-and-place machine, with the result that the integrated mounting performance of a production line is reduced.

Furthermore, a lighting device provided for image processing operations is known from EP 0 634 892 A1, which has a plurality of light emitting diodes. The light emitting diodes are affixed to a lighting module which can be secured to a camera module in a detachable manner by means of a screw connection.

### SUMMARY OF THE INVENTION

An advantage of the present invention is to create an optical sensor device for the visual detection of objects, which sensor device is simple to use and is suitable for a large number of different objects to be detected. Another advantage of the invention is also to create embodiments of individual components of the optical sensor device.

These and other objects and advantages are achieved by an optical sensor device, optical base module, and supplemental optical module detailed below.

The present intention is based on the knowledge that by using an optical sensor device constructed on a modular basis it is possible to make available suitable lighting required for detection purposes for almost all applications, in other words for almost all objects that are detected for the purpose of automatically equipping printed circuit boards with components in order to achieve fast and precise mounting.

According to the invention, the optical base module has a second or supplemental lighting unit. The spectral distribution and the lighting angle of the light emitted by this second lighting unit can be configured in such a way that a large portion of all applications, for example 80% of all objects conceivable in this context, are capable of being detected. In addition, the optical base module can be manufactured cost-effectively and thus contributes to a low basic price for automatic pick-and-place machines. For the situation where objects are to be detected which cannot be detected using the optical base module alone, a supplemental optical module can be used which makes available a special lighting facility for the objects to be detected and their respective backgrounds. Different supplemental optical modules can thus be offered, for example, which jointly cover all special applications. In this manner, the user of an automatic pick-and-place machine is able to purchase the supplemental optical modules required for his specific application from the manufacturer of the sensor device or from the manufacturer of the automatic pick-and-place machine.

The present optical sensor device further has the advantage that through the choice of different lighting angles or of different spectral distributions it is possible to illuminate all possible combinations of objects to be detected and backgrounds, in front of which the objects to be detected are located, with a light suitable for ensuring reliable detection of the objects. It should be noted that each lighting unit which is associated with the optical base module or the supplemental optical module is capable of emitting light in a plurality of different spectral ranges.

The supplemental optical module can be secured mechanically to the optical base module. This has the advantage that no separate fixing device needs to be provided for fitting the supplemental optical module and that in addition the supplemental optical module is always located in a spatially fixed position relative to the optical base module.

The supplemental optical module can be coupled directly or indirectly to the optical base module by way of an interface, Advantageously, this interface can be designed in such a manner that the supplemental optical module is contacted by way of the interface. This contact can be used for power supply purposes to the lighting units located in the supplemental optical module. An additional advantage of the coupling between the optical base module and the supplemental optical module by way of an interface includes the fact that the illumination characteristics, in other words the lighting angle and the spectral distribution of the illumination, can be determined centrally by a control unit which is linked by way of the interface both with the optical base module and also with the supplemental optical module. Accordingly, the connector facilitates an exchange of information between the supplemental optical module and external devices.

The interface between the optical base module and supplemental optical module is designed such that the supplemental optical module or the type of illumination by the supplemental optical module can be identified on the basis of data that is transferred over the interface. Thus, if the illumination characteristics of the supplemental optical module are known, calibration of the optical sensor device can be performed automatically by using the data transferred over the interface.

### BRIEF DESCRIPTION OF THE SEVERAL VIEWS OF THE DRAWINGS

Further advantages and features of the present invention will emerge from the description which follows, by way of example, of currently preferred embodiments. In the drawings:

FIG. 1 depicts an optical sensor device having a first supplemental optical module in accordance with a first embodiment of the invention; and

FIG. 2 depicts an optical sensor device having a second supplemental optical module in accordance with a second embodiment of the invention.

### DETAILED DESCRIPTION OF THE INVENTION

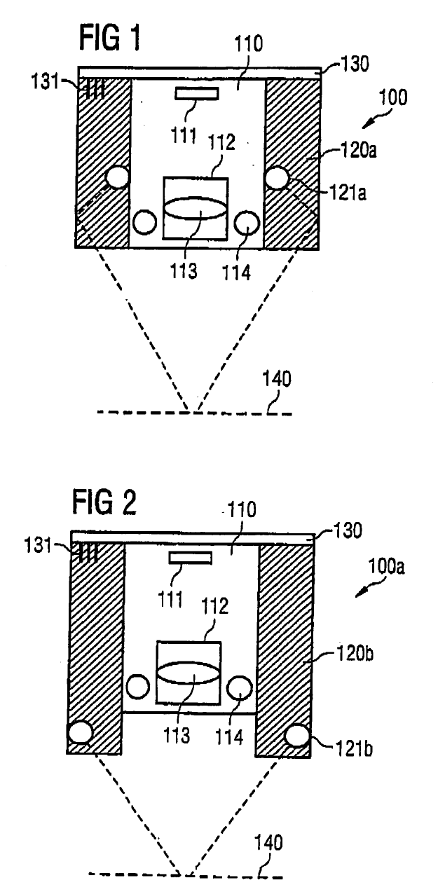

FIG. 1 depicts an optical sensor device 100, constructed on a modular basis, comprising an optical base module 110 and a supplemental optical module 120a. Via the optical sensor device 100, it is possible to detect objects whose surface to be detected lies in the working plane 140. The optical base module 110 comprises lighting elements 114, an imaging optical system 112, including for example a lens 113, and a CCD array or camera 111. The imaging optical system 112 images the object to be detected (not shown) onto the CCD 111. It should be noted that the imaging optical system 112 is represented only schematically in FIG. 1 and may also include a plurality of optical elements such as other lenses, beam splitters and/or mirrors. It should likewise be noted that in addition to the lighting elements 114 the optical base module can also have further lighting elements which directly or indirectly illuminate the object located in the working plane 140.

The supplemental optical module 120a has lighting elements 121a which in accordance with the embodiment of the invention shown here illuminate an object (not shown) located in the working plane 140 from a different angle than the lighting elements 114. Furthermore, the light emitted by the lighting elements 121a exhibits a different spectral distribution than the light which is emitted by the lighting elements 114 of the optical base module 110. At this point, it should likewise be noted that the supplemental optical module 120a in FIG. 1 is represented only schematically and may include further optical components such as additional lighting elements, imaging optical systems, beam splitters and/or mirrors. In accordance with the embodiment shown here, the supplemental optical module 120a is mounted onto the optical base module 110. When mounting the supplemental optical module 120a, a contact is established by way of an interface 131 between the optical base module 110 and the supplemental optical module 120a. In accordance with the embodiment shown here, this interface is situated on a base plate 130, to which both the optical base module 110 and also the supplemental optical module 120a can be secured.

In accordance with the depicted embodiment of the invention, data which is characteristic of the type of the supplemental optical module 120a or of the type of the illumination, which is provided by the supplemental optical module 120a, may be transferred over the interface 131. The illumination can thus be determined both by means of the optical base module 110 and by means of the supplemental optical module 120a via a central control unit which (not shown) and thus the optimum illumination for the respective application can be generated both in respect of spectral distribution and also in respect of the angular distribution.

FIG. 2 shows an optical sensor device 10a which differs from the optical sensor device 100 shown in FIG. 1 by virtue of a different supplemental optical module 120b which is likewise mounted onto the optical base module 110. Insofar as the reference characters from FIG. 2 match those from FIG. 1, they refer in each case to individual components which are present in identical form both in the sensor device 100a and also in the sensor device 100.

The supplemental optical module 120b has lighting elements 121b which illuminate an object (not shown) located in the working plane 140. In this situation, the illumination which is produced by the supplemental optical module 120b differs from the illumination produced by the supplemental optical module 120a by virtue of a different lighting angle, by virtue of a different spectral distribution of the illumination, and by virtue of a different distance between the lighting elements 121a and the object to be detected.

It should be noted that the supplemental optical module 120b in FIG. 2 is represented only schematically and apart from the lighting elements 121b can additionally contain further lighting elements, imaging optical systems, beam splitters and/or mirrors.

To summarize, the invention creates an optical sensor device 100 constructed on a modular basis having an optical base module 110 and a supplemental optical module 120a. The supplemental optical module 120a can be located on the optical base module and can be replaced by other supplemental optical modules 120b. The supplemental optical modules 120a, 120b are characterized by different illumination characteristics. In this manner, depending on the type of the object to be detected, a supplemental module 120a, 120b which is suitable in respect of the lighting angle and the spectral distribution of the illumination light can be selected. In accordance with one embodiment of the invention, the optical base module 110 is linked to the supplemental optical module 120a, 120b by way of an interface 131, with the result that the supplemental optical module 120a, 120b used in each case can be identified by a central control unit and thus in the event of switching the supplemental optical module 120a, 120b there is no longer any need to perform a calibration of the optical sensor device 100.

I claim:

1. An optical sensor device for the visual detection of objects including position detection and recognition or checking of components or substrates, comprising;
a light detector,
an imaging optical system which images an area of measurement for an object to be detected onto the light detector,
a first lighting unit which illuminates the area of measurement, and
a second lighting unit which illuminates the area of measurement, wherein
the light detector, the imaging optical system and the second lighting unit are located in an optical base module, the first lighting unit is located in a supplemental optical module, and the supplemental optical module may be detachably mounted on the optical base module.

2. The device according to claim 1, wherein the first and second lighting units are configured such that the object to be detected is illuminated by the second lighting unit from a different angle to the first lighting unit.

3. The device according to claim 1, wherein the first lighting unit emits light in a first spectral range and the second lighting unit emits light in a second spectral range.

4. The device according to claim 1, wherein at least one of the first and second lighting unit comprises at least one light emitting diode.

5. The device according to claim 1, wherein the light detector is a CCD camera.

6. The device according to claim 1, wherein the supplemental optical module is mechanically securable to the optical base module.

7. The device according to claim 6, wherein the supplemental optical module is mountable on the optical base module.

8. The device according to claim 1, wherein the supplemental optical module is directly or indirectly coupleable to the optical base module by way of an interface.

9. The device according to claim 8, wherein the interface comprises means for transferring data, the data being characteristic at least one of the supplemental optical module and the type of illumination provided by the supplemental optical module.

10. An optical sensing device for illuminating and detecting objects in a working plane, comprising:
an optical base module including a first light source arranged to direct a first light onto the working plane;
connecting means attached to the optical base module;
a supplemental optical module including a second light source arranged to direct a second light onto the working plane, the supplemental optical module interchangeably mounted onto the base module via the connecting means.

11. The device according to claim 10, wherein the supplemental optical module is mounted such that the first light shines upon the working plane at a different angle to the second light.

12. The device according to claim 10, wherein the connecting means comprises means for facilitating communication of data between the supplemental optical module and an external device.

13. The device according to claim 12, wherein the data is control data and the external device is a processor programmed to selectively control operation of the supplemental optical module.

14. The device according to claim 10, wherein the supplemental optical module comprises internally reflective walls arranged to reflect light from the second light source out of the supplemental optical module.

15. The device according to claim 10, wherein the supplemental optical module is longer than the optical base module in a direction of the working plane.

16. The device according to claim 10, wherein the optical base module further comprises;
a CCD array; and
a lens arrangement positioned to direct light from the working plane onto the CCD array.

17. The device according to claim 10, wherein the first and second light comprise different spectral distributions.

18. The device according to claim 10, wherein at least one of the first and second light sources comprise at least one of; a laser, a light emitting diode and an incandescent lamp.

19. An optical sensing device, comprising an optical base module and an interchangeable supplemental optical module.

20. A system for controlling a lighting device for pick and place machines comprising:
a first and second lighting means mounted on a base;
a processor programmed to selectively control the second light means; and
connecting means positioned between the second lighting means and the base, the connecting means facilitating communication between the second light means and processor.
